(19) United States
(12) Patent Application Publication
(10) Pub. No.: US 2024/0010513 A1
(43) Pub. Date: Jan. 11, 2024

(54) GERMANIUM EXTRACTION FROM ELECTRONIC WASTE

(71) Applicant: Arizona Board of Regents on Behalf of the University of Arizona, Tucson, AZ (US)

(72) Inventors: Fatemeh Molaei, Tucson, AZ (US); Hossein Siavoshi, Tucson, AZ (US); Rasoul Khosravi, Tucson, AZ (US)

(21) Appl. No.: 18/346,388

(22) Filed: Jul. 3, 2023

Related U.S. Application Data
(60) Provisional application No. 63/358,078, filed on Jul. 1, 2022.

(51) Int. Cl. C01G 17/02; C22B 7/00; H01M 10/54

(52) U.S. Cl. CPC C01G 17/02; C22B 7/007; H01M 10/54; C01P 2004/61

(57) ABSTRACT

This present disclosure is directed to a method of extracting germanium from a solid material, comprising: (a) grinding a solid material comprising germanium to generate a mixture of particulate solids; and (b) leaching the mixture with a leaching solution; wherein the leaching solution comprises water and a lixiviant; and wherein the lixiviant comprises at least an organic acid.

### CROSS REFERENCE TO RELATED APPLICATIONS

This application claims priority to U.S. Application No. 63/358,078, filed on Jul. 1, 2022, the contents of which are hereby incorporated by reference in its entirety.

### FIELD OF THE INVENTION

The field of the invention relates generally to extraction of germanium from solid materials, and more specifically extraction of germanium from electronic waste materials.

### BACKGROUND

The future of electronic, optic, telecommunication and solar energies industries is associated with germanium (Ge) availability and costs of processing (Kamran Haghighi et al., 2019; Liu et al., 2015). In electronic industries, germanium used as an electric semiconductor metalloid to produce small high-speed transistors and diodes. For this purpose, molten highly purified Ge is doped by adding minute quantities of arsenic, gallium or other elements. In optic fibers, germanium can increase the refractive index of pure silica glass core cables which is reducing signal loss in long distances (Mercer, 2015). Compared to Al, Nd, Yb, Er and Sm doped optic fibers (Hashim et al., 2009; Noor et al., 2011), Ge-doped ones have higher thermoluminescence and transmission capacity in small physical size and lower costs (Noor et al., 2014; Zhang and Xu, 2016). Germanium is also used for production of solar PV panels, high-brightness light emitting diodes (LEDs), backlighting of liquid crystal display (LCD), Gamma and X-ray detectors, medical devices such as chemotherapy and transparent to infrared radiation lenses and windows (Jorgenson, 2003; Schulz et al., 2017).

Due to application in high-tech industries and low availability, germanium was categorized as a strategic element according to the list of Critical Raw Materials for the European Union (Drzazga et al., 2019; European Commission, 2017). The Germanium concentration in Earth's crust is just 7 ppm (Moskalyk, 2004). According to the U.S. Geological Survey report, the world reserve of germanium is just 8600 tons (Chen et al., 2018). Industrially, germanium is produced as by-product of zinc, silver, lead, and copper industries. In addition, high concentrations of Ge are found in certain coals. With 30% of germanium reserves, coal deposits in China, Russia and Uzbekistan make important source of this strategic element (Mercer, 2015). Among all mentioned resources for Ge, zinc refining of primary concentrates is the most important source for producing germanium.

As an environmentally friendly suite of technologies with low energy consumption and zero gasses emission (Moosakazemi et al., 2019b), hydrometallurgy is the main method to extract Ge from different resources. Although several studies were carried out for Ge recovery from industrial wastes such as by-product of zinc metallurgy (Rao et al., 2019; Zhang et al., 2016), copper smelting residuals (Lehmann et al., 2019), and fly ash (Zhang and Xu, 2016), fewer studies were conducted for Ge extraction from electronic wastes (Chen et al., 2017; Dhiman and Gupta, 2020; Kuroiwa et al., 2014). Chen et al. (2017) recovered germanium from waste optical fibers. Ge leaching was investigated using HCl, HNO₃, H₂SO₄, and HF. The results indicated that by using 0.1M H₂SO₄ and 5% HF 98.3% of Ge was dissolved after 3 h reaction at room temperature. The most important disadvantage of this method is using hydrofluoric acid, which is a highly corrosive and expensive reagent. In other research by (Kuroiwa et al., 2014), the Ge extraction from waste solar panels was investigated. In this paper, alkali solution (0.1 M NaOH) was used for Ge leaching. Both HF and NaOH are required to destroy the silicate structure and make Ge atoms expose to the reagent.

### SUMMARY

There are significant opportunities to meet the future demand of germanium (Ge) by concentrating recovery efforts in the extraction and beneficiation/smelting/refining stages.

In some aspects, the invention provides:
a method of extracting germanium from electronic waste, comprising:
   a) grinding an electronic waste material comprising germanium to generate a mixture of particulate solids;
   b) leaching the mixture of particulate solids with a leaching solution;
   wherein the leaching solution comprises water and a lixiviant; and
   wherein the lixiviant comprises at least an organic acid.

In some embodiments, the organic acid has a pKa in a range of from about 4 to about 5.

In some embodiments, the organic acid is miscible with water at 25° C.

In some embodiments, the organic acid comprises acetic acid.

### BRIEF DESCRIPTION OF THE DRAWINGS

FIG. 1 represents a schematic image of the general structure of a germanium diode.

FIG. 2 represents the SEM-EDS analysis of diode sample before processing. FIG. 2 shows the results for diode sample particles prior to leaching experiments, showing that the particles surface was smooth.

FIG. 3 represents the XRD pattern of non-magnetic fraction of ground germanium diodes. Reference codes for identification of SiO₂, GeO₂ (Hexagonal), GeO₂ (Tetragonal), Ge, Bi₂GeO₅, and GeAs₂ are 01-078-1259, 01-083-2475, 01-072-1149, 96-901-2000, 01-078-1334, and 01-073-1393.

FIG. 4 represents Gibbs free energy of formation for GeO and GeO₂ for both direct and indirect mechanisms as a function of temperature.

FIG. 5 represents the speciation diagram of acetic acid (5.0 M). The specified dashed rectangular shows the approximate range of experiments condition, wherein the graph was established using the Medusa software (Royal Institute Technology, Sweden).

FIG. 6 represents an Eh-pH diagram of Ge—H₂O system at 25° C., which was drawn by HSC 6.0 chemistry software.

FIG. 7A represents the effect of germanium extraction versus time at different acetic acid concentrations at 450 RPM and 90° C.

FIG. 7B represents the observed influence of stirring speed in the range of 300 to 650 RPM on germanium extraction under acid concentration and temperature of 2.5 M and 90° C., respectively.

FIG. 7C represents the observed effect of temperature ranging from 30° C. to 90° C. on germanium extraction at 2.5 M acid and 450 RPM.

FIG. 8A represents kinetic modeling of Ge dissolution at different acid concentrations.

FIG. 8B represents kinetic modeling of Ge dissolution at different agitation speeds.

FIG. 8C represents kinetic modeling of Ge dissolution at different temperatures.

FIG. 9A represents an SEM image from leaching residual after 5 minutes.

FIG. 9B represents an SEM image from leaching residual after 90 minutes.

FIG. 9C represents an SEM image from leaching residual after 200 minutes.

FIG. 9D represents an SEM image from leaching residual after 360 minutes.

### DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

As used herein, the term “mineral acid” refers to an inorganic acid having a pKa value less than about 3, and includes HCl, HNO₃, H₂SO₄, and HF.

The term “electronic waste” as used herein includes whole devices, such as televisions, computers, phones, audio and video recorders, cameras, printers, peripheral devices, and countless other electronic devices. Electronic waste also includes electronic parts, components, and raw materials used in the manufacturing of electronic devices. The term “electronic waste” also includes particulate solid electronic waste obtained from grinding electronic waste that have been grounded into particles (e.g., particles of a size that is too large for leaching using the methods disclosed herein). Electronic waste can include valuable materials that could be recovered and re-used in other products. The number of electronic devices manufactured and subsequently discarded has multiplied exponentially in recent years and is likely to continue to increase in the years to come. Some estimates forecast that the currently produced amount of electronic waste will double over the next decade.

It is desirable to have a safe and economically viable method for recovery of valuable materials from electronic waste. One such valuable material frequently found in electronic waste is germanium (Ge). The inventors have surprisingly found an effective method for extracting germanium by leaching from electronic waste, using acetic acid as a lixiviant.

Preferably, the electronic waste to be leached is a mixture of particulate solids to that have been grounded to generate smaller particulate solids that cen be optimally leached. The size of particles can be selected to optimize the leaching process. A useful range of particle size may include, for example, a particle size (d₈₀) of up to about 100 micrometers, up to about 75 micrometers, up to about 50 micrometers, up to about 15 micrometers, or even up to about 10 micrometers. In some embodiments, the range of particle size may be from about 1 to about 5 micrometers, from about 5 to about 10 micrometers, from about 10 to about 15 micrometers, from about 15 to about 20 micrometers, from about 20 to about 25 micrometers, from about 25 to about 30 micrometers, from about 30 to about 40 micrometers, from about 40 to about 50 micrometers, from about 50 to about 60 micrometers, from about 60 to about 70 micrometers, from about 70 to about 80 micrometers, from about 80 to about 90 micrometers, from about 90 to about 100 micrometers. One aspect of the invention pertains to a method of extracting germanium from a solid material, said method comprising grinding a glass diode comprising germanium to generate a mixture of ground particles with a d₈₀ value of about 15 micrometers or about 10 micrometers, and leaching germanium from said particles.

There is a need to reduce the electronic waste to particles of a suitable size for leaching, for example, by means of grinding, pulverizing, or otherwise reducing the electronic waste to particles.

In some embodiments, where the electronic waste is an electronic component (e.g., a glass diode), the component may have an electronic component body, and a wire extending therefrom (for example, a wire containing one or more metals). Where practicable, removal of the wires (or other appendages) from the electronic component body prior to the grinding step is preferred. In some embodiments, the electronic waste may be a glass diode. In some embodiments, the wire may contain one or more metals.

In some embodiments, a magnetic force may be applied to the mixture of particulate solids, in order to remove magnetic materials, including iron-containing materials. In some embodiments, a simple magnet such as a magnetic stir bar may suffice for removal of magnetic particles from the mixture of particulate solids.

Organic acids (such as acetic acid) are advantageous for several reasons, including a favorable safety profile and lower corrosion liability than stronger, mineral acids such as HCl, HNO₃, H₂SO₄, HF, HBr, and the like.

Organic acids with a pKa of about 4 to 5 may be used as lixiviant in the methods disclosed herein. It is contemplated that other organic carboxylic acid compounds may have utility as lixiviants in the leaching of electronic waste. Suitable examples include C1-C6 mono- and dicarboxylic acid compounds, for example, propionic acid, butyric acid, and succinic acid. Tricarboxylic acids such as citric acid are contemplated. A suitable organic acid should have sufficient water solubility to permit effective leaching, and preferably be miscible with water.

In some embodiments, the amount of germanium in the electronic waste is in a range of, for example, about 0.5 ppm to about 10000 ppm, about 0.5 ppm to about 5000 ppm, about 0.5 ppm to about 1000 ppm, about 0.5 ppm to about 500 ppm, about 0.5 ppm to about 100 ppm, about 0.5 ppm to about 50 ppm, about 0.5 ppm to about 10 ppm, about 0.5 ppm to about 5 ppm, about 0.5 ppm to about 2 ppm, or even about 0.5 ppm to about 1 ppm.

In some embodiments, the invention provides methods for the recovery of Ge from germanium-diodes, using acetic acid (CH₃COOH) as an organic and environmentally friendly reagent. The effects of parameters including acid concentration, agitation speed, and temperature were investigated on Ge leaching and optimum conditions to obtain the highest germanium recovery were suggested. In addition, kinetic modeling was carried out to determine the effect of each of these parameters in the leaching mechanism.

In some embodiments, the concentration of acetic acid in the leaching solution may be from about 0.1M to about 1M, from about 1M to about 2M, from about 2M to about 3M, from about 3M to about 4M, from about 4M to about 5M, from about 5M to about 6M, from about 6M to 7M, from about 7M to about 8M, from about 8M to about 9M, from about 9M to about 10M, from about 10M to about 11M, or from about 11M to about 12M.

In some embodiments, the leaching comprises agitating the mixture of particulate solids by stirring at a speed from about 100 rpm to about 150 rpm, from about 150 rpm to about 200 rpm, from about 200 rpm to about 250 rpm, from about 250 rpm to about 300 rpm, from about 300 rpm to about 350 rpm, from about 350 rpm to about 400 rpm, from about 400 rpm to about 450 rpm, from about 450 rpm to about 500 rpm, from about 500 rpm to about 550 rpm, from about 550 rpm to about 600 rpm, from about 600 rpm to about 650 rpm, from about 650 rpm to about 700 rpm, from about 700 rpm to about 750 rpm, from about 750 rpm to about 800 rpm, or from about 800 rpm to about 850 rpm.

In some embodiments, the leaching is carried out at a temperature of at least about 18° C., at least about 19° C., at least about 20° C., at least about 21° C., at least about 22° C., at least about 23° C., at least about 24° C., at least about 25° C., at least about 26° C., at least about 27° C., at least about 28° C., at least about 29° C., or at least about 30° C.

In some embodiments, the leaching is performed for a duration of from about 2 minutes to about 5 minutes, from about 5 minutes to about 10 minutes, from about 10 minutes to about 30 minutes, from about 30 minutes to about 60 minutes, from about 60 minutes to about 90 minutes, from about 90 minutes to about 120 minutes, from about 120 minutes to about 150 minutes, from about 150 minutes to about 180 minutes, from about 180 minutes to about 210 minutes, from about 210 minutes to about 240 minutes, from about 240 minutes to about 270 minutes, from about 270 minutes to about 300 minutes, from about 300 minutes to about 330 minutes, from about 330 minutes to about 360 minutes, or from about 360 minutes to about 390 minutes.

In some embodiments, the leaching solution and mixture of particulate solids have an initial volume/weight ratio from about 5:1 to about 10:1, from about 10:1 to about 50:1, from about 50:1 to about 100:1, from about 100:1 to about 200:1, from about 200:1 to about 300:1, from about 300:1 to about 400:1, from about 400:1 to about 500:1, from about 500:1 to about 600:1, from about 600:1 to about 700:1, from about 700:1 to about 800:1, from about 800:1 to about 900:1, from about 900:1 to about 1000:1, from about 1000:1 to about 1100:1, or from about 1100:1 to about 1200:1.

In some embodiments, the leaching is carried out at a pressure of from about 0.01 MPa to about 0.1 MPa, from about 0.1 MPa to about 1 MPa, from about 1 MPa to about 2 MPa, from about 2 MPa to about 3 MPa, from about 3 MPa to about 4 MPa, from about 4 MPa to about 5 MPa, from about 5 MPa to about 6 MPa, from about 6 MPa to about 7 MPa, from about 7 MPa to about 8 MPa, from about 8 MPa to about 9 MPa, from about 9 MPa to about 10 MPa, from about 10 MPa to about 11 MPa, or from about 11 MPa to about 12 MPa.

### List of Embodiments

The following is a non-limiting list of embodiments:
Embodiment 1. A method of extracting germanium from electronic waste, comprising:
   a) grinding an electronic waste material comprising germanium to generate a mixture of particulate solids;
   b) leaching the mixture of particulate solids with a leaching solution;
   wherein the leaching solution comprises water and a lixiviant; and
   wherein the lixiviant comprises at least an organic acid.
Embodiment 2. The method of embodiment 1, wherein the organic acid has a pKa value in a range of from about 4 to about 5.
Embodiment 3. The method of embodiment 1, wherein the organic acid is miscible with water.
Embodiment 4. The method of embodiment 1, wherein the lixiviant further comprises a mineral acid.
Embodiment 5. The method of embodiment 1, wherein organic acid comprises at least one carboxylic acid group (e.g., R—CO₂H where R is C1 to C5 alkyl, such as acetic acid, propionic acid, butyric acid; dicarboxylic acids can include succinic acid; tricarboxylic acids can include, e.g., citric acid).
Embodiment 6. The method of embodiment 1, wherein organic acid comprises at least one carboxylic acid group such as R—CO₂H, wherein R is C1 to C5 alkyl.
Embodiment 7. The method of embodiment 6, wherein organic acid consists of an organic acid selected from the group comprising acetic acid, propionic acid, butyric acid, and combinations thereof.
Embodiment 8. The method of embodiment 1, wherein organic acid comprises dicarboxylic acids.
Embodiment 9. The method of embodiment 8, wherein organic acid comprises succinic acid.
Embodiment 10. The method of embodiment 1, wherein organic acid comprises tricarboxylic acids.
Embodiment 11. The method of embodiment 10, wherein organic acid comprises citric acid.
Embodiment 12. The method of embodiment 1, wherein the organic acid comprises acetic acid.
Embodiment 13. The method of embodiment 1, wherein the organic acid is acetic acid.
Embodiment 14. The method of any one of embodiments 1 to 13, wherein said method further comprises removing magnetic particles from the mixture of particulate solids prior to step b).
Embodiment 15. The method of any one of embodiments 1 to 14, wherein the electronic waste comprises any one of an optical fiber, a diode (e.g., a glass diode a light-emitting diode, etc.), a liquid crystal display, an electronic semiconductor, a battery, a solar panel, or a circuit board (e.g., printed circuit board).
Embodiment 16. The method of any one of embodiments 1 to 15, wherein the electronic waste comprises a printed circuit board.
Embodiment 17. The method of any one of embodiments 1 to 16, wherein the electronic waste comprises an electronic component.
Embodiment 18. The method of embodiment 17, wherein said electronic component comprises an electronic component body and at least one wire (e.g., a wire containing one or more metals) extending therefrom, wherein the germanium is enclosed within the electronic component body.
Embodiment 19. The method of embodiment 18, further comprising removing the at least one metallic wire from the electronic component body prior to step a).
Embodiment 20. The method of any one of embodiments 1 to 19, wherein the mixture of particulate solids comprises GeO and/or GeO₂.
Embodiment 21. The method of any one of embodiments 1 to 20, wherein germanium is present in the mixture of particulate solids in an amount up to about 10000 ppm.
Embodiment 22. The method of any one of embodiments 1 to 21, wherein the organic acid is acetic acid and wherein the concentration of acetic acid in the leaching solution is in a range of from about 1 M to about 10 M.
Embodiment 23. The method of any one of embodiments 1 to 22, wherein the leaching comprises agitating the mixture of particulate solids by stirring, e.g., at a speed in a range of from about 250 rpm to about 700 rpm.
Embodiment 24. The method of any one of embodiments 1 to 23, wherein the leaching is carried out at a temperature of at least about 25° C.
Embodiment 25. The method of any one of embodiments 1 to 24, wherein the leaching is performed for a duration of from about 5 minutes to about 360 minutes.
Embodiment 26. The method of any one of embodiments 1 to 25, wherein the mixture of particulate solids has a particle size distribution in a range of from about 10 micrometers to about 100 micrometers.
Embodiment 27. The method of any one of embodiments 1 to 26, wherein the leaching solution and mixture of particulate solids have an initial volume/weight ratio in a range of from 10:1 to about 1000:1.
Embodiment 28. The method of any one of embodiments 1 to 27, wherein the leaching is carried out at a pressure in a range of from about 0.1 MPa to about 10 MPa.
Embodiment 29. Recovered germanium, wherein said germanium is recovered using a method of embodiment 1.

### Examples

The following examples are provided solely to illustrate the present invention and are not intended to limit the scope of the invention, described herein.

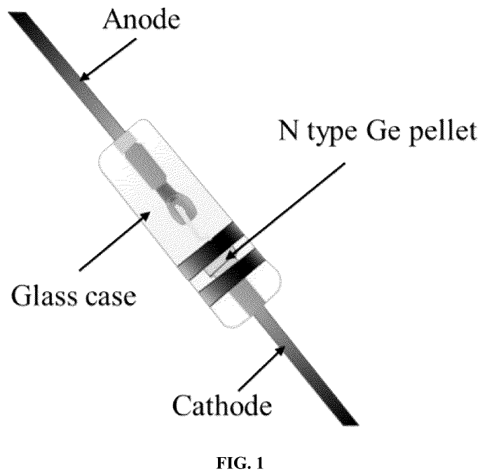

A batch of 500 germanium diodes known by manufacturer number of 1N60 was purchased from a local supplier. FIG. 1 represents a schematic image of the general structure of a germanium diode.

All metallic anode and cathode were cut using a metal guillotine cutter as close as possible to the glass case of the diode to avoid much contamination in further processes. A ring mill was employed to grinding the free-anode/cathode diodes. In each step, around 100 diodes were ground for 5 minutes to liberate germanium pellets from the glass casing and size reduction to provide more surface area to attack by lixiviants. Ground particles were immersed in deionized water and homogenized using a magnetic stirrer. Magnetic particles attached to the magnetic stir bar were manually removed; this process continued until all magnetic materials were separated. The removal of magnetic particles was performed to reduce reagent consumption and facilitate further purification.

Leaching Experiments

Leaching experiments were carried out in a 0.5 L glass reactor equipped with a reflux condenser to recycle evaporated water and lixiviant and a port designated for sampling and temperature control. This reactor was placed on a hot plate in a water bath provided with a magnetic stirrer to adjust and maintain a certain temperature. At predefined times, 1 mL of leaching solution was withdrawn and diluted in a 25 mL flask to analyze Ge by ICP-OE (Inductively Coupled Plasma Optical Emission spectroscopy). Leaching experiments were designed to investigate the effect of lixiviant concentration, stirring speed, and temperature. Liquid to solid ratio of 100:1 (v/wt.) was fixed for all experiments. Therefore, 1.00 g of non-magnetic ground diodes were added to the leaching solution (100 mL) after heating to the desired temperature. According to the shrinking core model, the kinetics modeling should ideally be carried out for a single particle. Due to small size of particles, it was impractical to operate the leaching tests with one particle. Therefore, the tests were carried out at low pulp densities to provide this condition (Sina Ghassa et al., 2017; Moosakazemi et al., 2019a). Acetic acid as the lixiviant was used with concentrations of 2.5, 5, and 7.5 M. This organic acid with the chemical formula of CH₃COOH is an environmentally friendly lixiviant, which could be recycled or even disposed easily without any environmental concerns after the dissolution (Asadi et al., 2018). Stirring speeds of 300, 450, and 600 RPM were chosen to study their impact on proper mixing. The effect of temperature was also evaluated in the range of 30-90° C. (in intervals of 20° C.).

Results and Discussion

Characterization

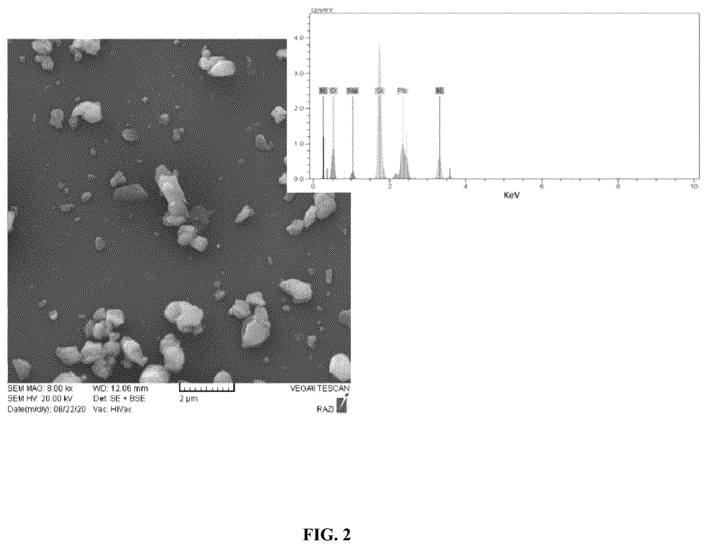

Scanning electron microscope (SEM) and energy-dispersive X-ray spectroscopy (EDS) were employed to determine the surface morphology and chemical compositions. The results shown in FIG. 2 were for the diode sample particles prior to leaching experiments, showing that the particles surface was smooth.

The EDS analysis indicated that the sample was composed mainly of silicon (23%) and oxygen (56%). In addition, diode sample contained 10% lead, 6% potassium, and 3% sodium. The germanium was not detected in EDS analysis due to its low concentration. To determine the Ge concentration, a subsample of non-magnetic ground diodes was digested using alkaline roasting with NaOH at 450° C. for 1 h in a nickel crucible and then leached in a concentrated HCl solution. The solution was analyzed by an inductively coupled plasma optical emission spectroscopy (ICP-OES: Perkin Elmer OPTIMA 5300 DV). It was found that Ge content in the non-magnetic fraction of diodes was 5092 ppm.

Measurements of the size distribution of non-magnetic ground particles were conducted using an ANALYSETTE 22 NANOTEC laser particle sizer (FRITSCH GmbH Co.). The results indicated that 80% of particles (d₈₀) were smaller than 14.84 micrometers.

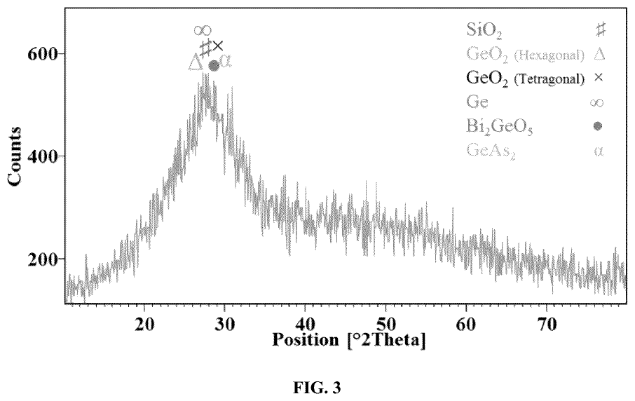

Phase characterization of the non-magnetic fraction was performed using an X-ray diffractometer (XRD: Philips PW 3710). XRD pattern was evaluated employing the HIGHSCORE PLUS software (V. 3.0.5, PANalytical B.V.). FIG. 3 shows the XRD pattern of the non-magnetic particles.

There was a broad peak around position (2θ) of 28 degrees, consistent with an amorphous structure generated during synthesis of diode body or even from the impact of fine grinding. Based on the data search in HIGHSCORE PLUS software and literature, without wishing to be bound by a particular theory, this broad peak could be assigned to SiO₂ and germanium compounds including polymorphs of GeO₂ (Hexagonal and tetragonal), Ge, Bi₂GeO₅, and GeAs₂. Pentavalent impurities also known as donor impurities such as bismuth and arsenic may be doped to pure germanium for the production of N-Type semiconductors. Formation of GeO₂ and GeO may be due to oxidation during grinding process. Without wishing to be bound by a particular theory, grinding in an oxygen-containing atmosphere (besides heating owing to the effect of mechanical process) oxidizes germanium to form GeO and GeO₂ either in indirect or direct mechanisms. In an indirect mechanism, germanium may initially convert to GeO and then the new compound may further oxidize to GeO₂, while in a direct mechanism, germanium may convert to the higher oxidation form of GeO₂ (Eqs. 1-3).

2Ge+O₂→2GeO (1)

2GeO+O₂→2GeO₂ (Indirect mechanism) (2)

2Ge+O₂→2GeO₂ (Direct mechanism) (3)

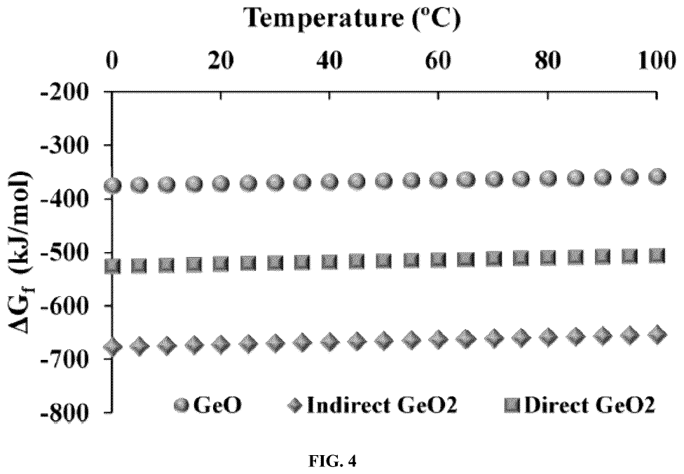

FIG. 4 shows the Gibbs free energy of formation for GeO and GeO₂ for both direct and indirect mechanisms. Loss of energy in grinding may contribute to heating, so a range of temperatures (0-100° C.) was considered for the thermodynamic evaluations. Variation of Gibbs free energy of formation in the range of temperature studied was considered to be negligible and it was assumed that all reactions (Eqs. 1-3) proceeded to completion. Based on the data presented in FIG. 4, direct conversion of Ge to GeO2 was more favorable compared to the indirect mechanism.

Leaching Chemistry

Acetic acid (CH₃COOH) is a green weak lixiviant that ionizes in aqueous solution to yield a H⁺ ion and a strong conjugate bas (CH₃COO⁻) by the following reaction (Eq. 4).

CH₃COOH=H⁺+CH₃COO⁻ (4)

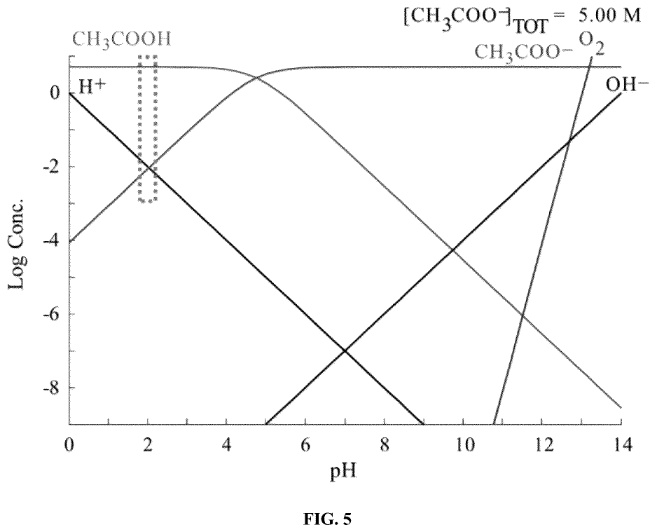

FIG. 5 shows the speciation diagram of acetic acid. Ionization of acetic acid is known to reduce by increasing its concentration, such that an increase in concentration from 1 to 7.5 M decreases ionization from 0.418% to 0.153%. Also, in the range of 1-7.5 M of acid pH varies between 2.38 and 1.94. Employing acetic acid as leaching reagent has some advantages over inorganic acids such as being degradable in environment under either aerobic or anaerobic conditions and lack emission of unsafe gases and substances.

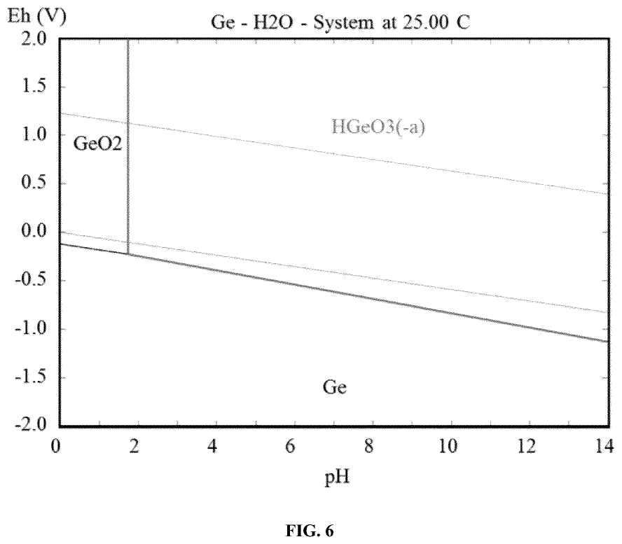

FIG. 6 shows the Eh-pH diagram of Ge—H₂O system at 25° C. The main aqueous species is HGeO₃⁻ at pH above 1.8. GeO₂ exists as the dominant solid compound, at pH below 1.8.

The formation of germanium complexes with acetic acid has been shown by (Pokrovski, G. S. and Schott, 1998). Therefore, the possible leaching reaction products could be aqueous Ge(CH₃COO)₄, HGeO₃⁻, and Ge⁴⁺. Thus, the leaching reaction of germanium dioxide, germanium monoxide, and germanium in acetic acid can be shown by Eqs. (5-8). This reaction proceeds depending on the efficient process variables including acid concentration, agitation speed, and temperature.

GeO₂+4CH₃COO⁻+4H⁺→Ge(CH₃COO)₄(aq)+2H₂O (5)

GeO₂+4H⁺→Ge⁴⁺+2H₂O (6)

GeO+2H⁺→Ge²⁺+H₂O (7)

Ge+4H⁺+O₂→Ge⁴⁺+2H₂O (8)

Leaching Studies

The results of leaching experiments of germanium diodes showed a particular behavior in extraction which is discussed below. Without wishing to be bound by a particular theory, considering all effective parameters, the leaching process occurred in 3 phases:

Very fast leaching (Phase 1): In this phase approximately 40-50% of the total germanium could be extracted in the first 5 minutes of the reaction. The fast rate of leaching could be attributed to GeO₂, which dissolves readily (Wood and Samson, 2006).

Suspension (Phase 2): This phase occurred immediately after Phase 1 in which the leaching process was suppressed for a time, the length of which depends on the reaction conditions.

Gradual leaching (Phase 3): This phase was identified after Phase 2 in which a gradual increase in germanium extraction could be observed. This phase would finally peter out because of insoluble Ge compounds in acetic acid solution.

The effect of each parameter will be explained below.

Acid Concentration

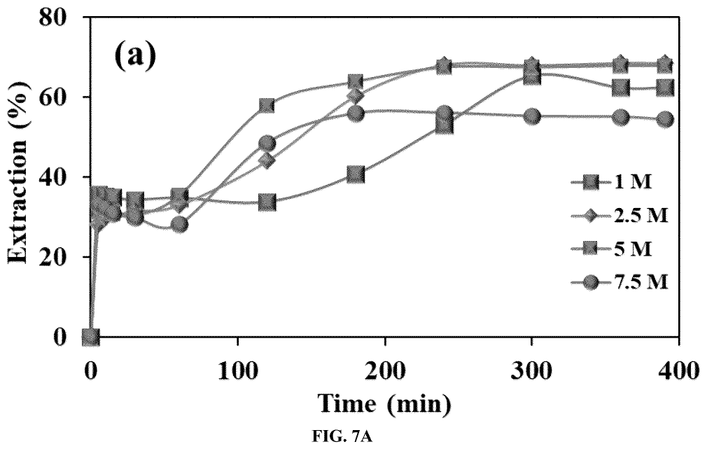

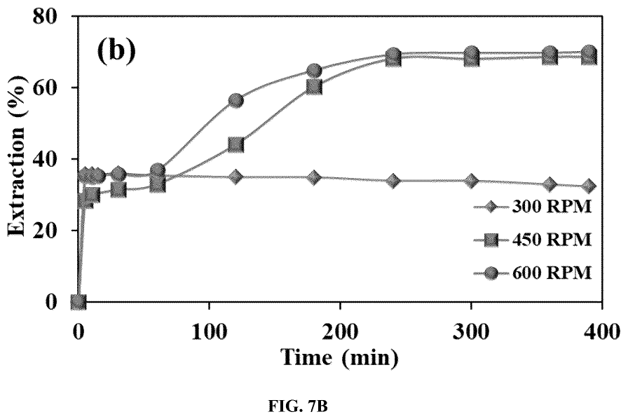

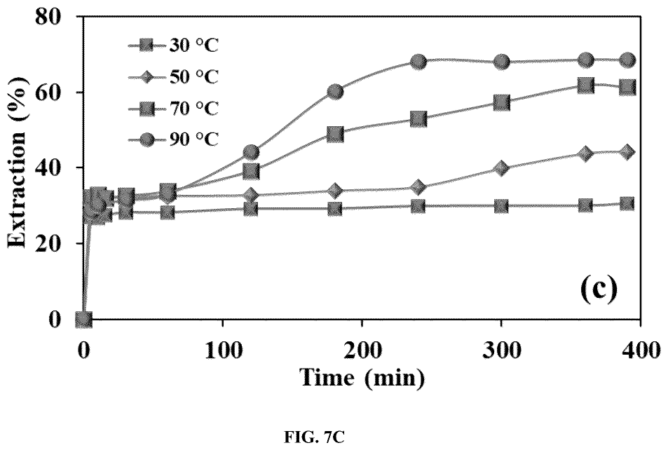

Effect of germanium extraction versus time at different acetic acid concentrations was shown in FIG. 7A. Based on the one factor at a time experimental design, stirring speed and temperature had been fixed at 450 RPM and 90° C., respectively. A significant and rapid increase for germanium extraction occurred in only 5 minutes of the experiments for all reagent concentrations (Phase 1). This fast rate of extraction could potentially be due to dissolution of the hexagonal GeO₂ which is more soluble than the tetragonal form (Jing et al., 2008; Wood and Samson, 2006), Ge and GeO (Gan et al., 2015). The extent of this fast leaching was more pronounced in the experiment with lower reagent concentration (i.e., 1 M), in which germanium was extracted to 39.7% while for the other concentrations this value was approximately 35%. After the initial rapid germanium extraction, the leaching process appeared to be suspended for 60 minutes for 2.5, 5, and 7.5 M acid concentrations, while it took approximately 120 minutes for experiments with reagent concentration of 1 M (Phase 2). After this hiatus a gradual increase for germanium extractions in all concentrations was observed, in which 2.5 M experiment experienced a higher leaching rate. Experiments with reagent concentrations of 5 and 7.5 M reached equilibrium after 180 minutes. Equilibrium time increased with decreasing reagent concentration; it took 240 and 300 minutes for experiments with reagent concentration of 2.5 and 1 M, respectively. The order of reagent concentration efficiency in term of maximum extraction was 2.5>5≥1>7.5 M. This result suggested that there may be a H⁺ and CH₃COOH⁻ concentration beyond which germanium extraction decreases. Therefore, the reagent concentration for germanium extraction was maintained to be 2.5 M for other experiments.

Stirring Speed

FIG. 7B shows the observed influence of stirring speed in the range of 300 to 650 RPM on germanium extraction under acid concentration and temperature of 2.5 M and 90° C., respectively. Germanium extraction reached equilibrium at the very initial times (<5 min) at 300 RPM. At stirring speeds of 450 and 600 RPM germanium extraction reached to about 31% and 37%, respectively, within 5 minutes and remained constant for the next 60 minutes of the leaching process (Phase 2). A gradual increase in extraction could be observed after 60 minutes for both higher stirring speeds till 240 minutes, after which, the process reached an equilibrium (Phase 3). The higher stirring speed may have promoted mass transfer and diffusion of reactants onto the solid surface (Wang et al., 2017). Although the rate of reaction for the higher speed (i.e., 600 RPM) was faster, total germanium extraction at stirring speeds of 450 and 600 RPM were comparable. It appeared that increasing the stirring speed increased energy consumption without improving the extraction process. Therefore, the stirring speed of 450 RPM was chosen for further experiments.

Temperature

The observed effect of temperature ranging from 30° C. to 90° C. on germanium extraction is shown in FIG. 7C. The results showed that temperature had a remarkable effect on the extraction process. A significant part of the contained germanium dissolved in 5 minutes for all experiments (Phase 1). The result for the experiment conducted at 30° C. indicated that the reaction reached equilibrium in just 5 minutes and germanium extraction stopped after that. Increasing temperature led to increasing germanium extraction during Phase 3. The higher the temperature, the faster the leaching rate, and the higher the total extraction achieved.

Kinetic Modelling

The effects of acid concentration, agitation rate and temperature were investigated on Ge leaching kinetics. For this purpose, different types of kinetics equations were fitted to data, to find the best fitted models and describe the reaction mechanisms. Chemical reaction control, diffusion control, mixed control model, mixed control model by shrinking core model, diffusion through product layer, diffusion through a porous product layer by shrinking core model, interfacial transfer and diffusion across the product layer, surface chemical reaction by shrinking core model, and diffusion of hydrogen ions through a product layer by shrinking core model were employed to find the kinetic mechanism of germanium leaching. The mathematical equations for kinetics models were as reported in Table 1 listed in previous papers.

TABLE 1
Different kinetics models used to study the Ge leaching kinetics.

| NO. | Model | Mechanism |
|---|---|---|
| (1) | ${k}_{t} = 1 - {( 1 - X )}^{\frac{1}{3}}$ | Chemical reaction control |
| (2) | ${k}_{t} = 1 - \frac{2}{3} X - {( 1 - X )}^{\frac{2}{3}}$ | Diffusion control |
| (3) | kₜ = −ln(1 − X) | Mixed control model (surface reaction control; and diffusion through product layer) |
| (4) | ${k}_{t} = 1 - {( 1 - X )}^{\frac{2}{3}}$ | Mixed control model by shrinking core model (diffusion control; chemical reaction control) |
| (5) | ${k}_{t} = {[ 1 - {( 1 - X )}^{\frac{1}{3}} ]}^{2}$ | Diffusion through product layer |
| (6) | ${k}_{t} = 1 - \frac{2}{3} X - {( 1 - X )}^{\frac{1}{3}}$ | diffusion through a porous product layer by shrinking core model |
| (7) | ${k}_{t} = \frac{1}{3} ln ( 1 - X ) + ( {( 1 - X )}^{\frac{1}{3}} - 1 )$ | Interfacial transfer and diffusion across the product layer |
| (8) | ${k}_{t} = 1 - {( 1 - 0.45 X )}^{\frac{1}{3}}$ | Surface chemical reaction by shrinking core model |
| (9) | ${k}_{t} = 1 - 3 {( 1 - X )}^{\frac{2}{3}} + 2 ( 1 - X )$ | and diffusion of hydrogen ions through a product layer by shrinking core model |

Effect of Acid Concentration

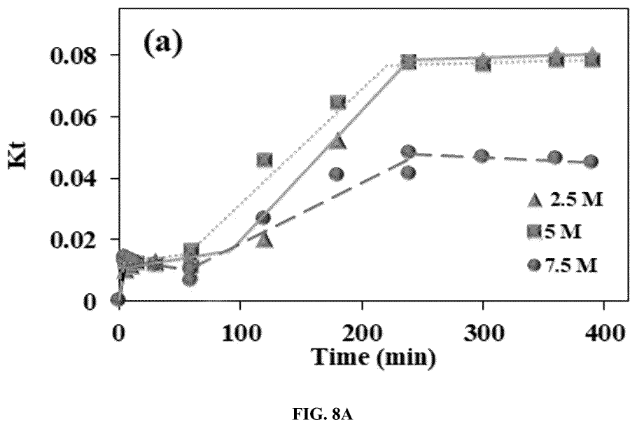

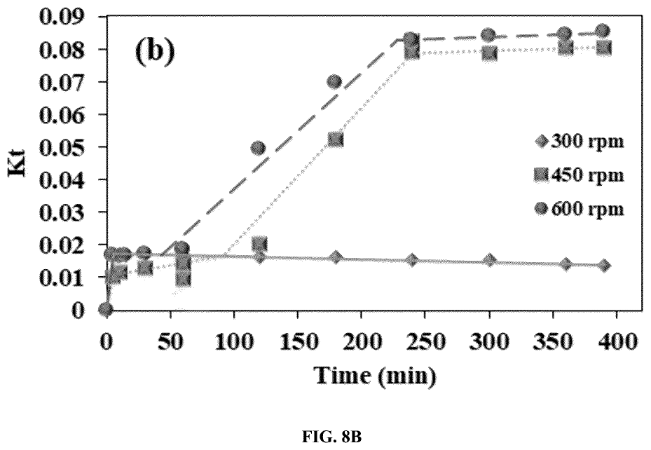

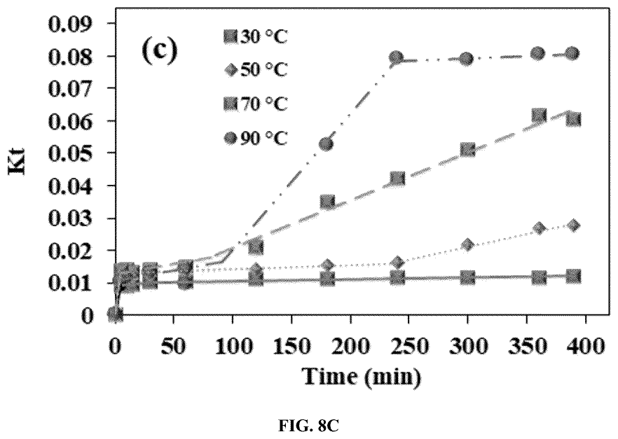

The results indicated that Ge leaching follows 3 different phases (FIG. 8A). During first 5 minutes, Ge rapidly dissolved and its recovery reached to around 35%. The leaching kinetic was very fast in this period and modelling the reactions was impractical. This fast kinetic period occurred with the dissolution of GeO₂. It may be postulated that the reaction was a chemical surface reaction, due to its rapid leaching. The kinetics modeling was consistent with a theory that diffusion control mechanism was the rate-limiting step for second phase, in all acid concentrations. The reaction rate coefficients for different parameters were as listed in Table 2.

The reaction rate coefficients for leaching with 2.5 M, 5 M, and 7.5 M at this phase were 6.61×10⁻⁵, 6.94×10⁻⁵, and −6.87×10⁻⁵, respectively. The reaction rate coefficients for this phase were very low which shows that the Ge dissolution was almost stopped in this phase. The diffusion control mechanism shows that during this phase solvent cannot access to the Ge atoms. As mentioned, Ge and GeO have lower solubility in comparison with GeO₂. In the second period, Ge and GeO oxidized to GeO which caused Ge dissolution reaction stopped.

This caused the leaching mechanism to shift from diffusion control to interfacial transfer and diffusion across the product layer, at the third phase. In other words, the germanium dissolution followed interfacial transfer and diffusion across the product layer mechanism in time period between 60 and 240 min. After this phase, the reaction reached equilibrium and reaction rate coefficients dropped to ˜0.

Effect of Agitation Speed

The kinetic modeling showed that the leaching process followed two mechanisms in the experiment with 300 rpm; while three mechanisms had an effect on Ge leaching in tests with 450 rpm and 600 rpm (FIG. 8B). The coefficients of determination were as listed in Table 2. Again, Ge recovery increased to ˜30% during first 5 min, for all experiments. In experiment with 300 rpm agitation speed, diffusion control was the rate-limiting step in a time period of 5-390 min with R²=0.96. The kinetic rate coefficient of −8.30×10⁻⁶ showed that Ge dissolution was stopped, and dissolved Ge precipitated with a very low slope. Unlike to the other experiments, the diffusion control was stable in this test and Ge atoms were not exposed to the acid. Without wishing to be bound by a particular theory, this phenomenon may have occurred because solid particles were not suspended (Moosakazemi et al., 2019b) at this agitation rate. In addition, decreasing in agitation rate decreased the oxygen diffusion to the liquid and Ge and GeO was not oxidized to GeO₂. By increasing the agitation speed, the particles suspension and oxygen diffusion increased, and Ge dissolution developed. The main portion of Ge was dissolved at a time period of 60-243 min after Ge and GeO oxidation, for tests with agitation speed of 450 rpm and 600 rpm. The interfacial transfer and diffusion across the product layer were the leaching mechanisms for tests at 450 rpm and diffusion control was rate limiting step for test with 600 rpm, at the mentioned time period. The kinetic rate coefficients for this time period were 0.00042 and 0.00036 for tests at 450 rpm and 600 rpm, respectively. This means that increasing the agitation speed decreased leaching rate. The reaction for tests with 450 rpm and 600 rpm reached to equilibrium after around 240 min.

Effect of Temperature

The Ge leaching kinetics were affected by temperature, significantly. The germanium leaching mechanism for experiments at temperatures 30, 50, and 70° C. covered 3 phases in 360 min and 3 phases for experiments 90° C. in 240 min (FIG. 8C). Fitting the kinetic models to data showed that the dominant mechanism for all phases at 30° C., 50° C., and 70° C. was diffusion control. Again, at all temperatures, around 30% of germanium was dissolved at first 5 minutes. At 30° C., the Ge also dissolved between 5 to 30 min, with a very low kinetic rate (Table 2); while Ge leaching stopped after 30 min. by increasing the temperature to 50° C., the leaching process occurred with very low kinetic until 240 min; however, based on diffusion control equation

$$( 1 - \frac{2}{3} x - {( 1 - x )}^{\frac{2}{3}} )$$

the reaction rate coefficient increased from 1.32×10⁻⁵ M/s to 7.86×10⁻⁵ M/s after 240 min. Although the kinetic rates for test at 70° C. were high in comparison with tests at lower temperatures, the kinetic mechanism for these three tests were similar. The reaction reached to equilibrium step after around 240 min.

By increasing the process temperature to 90° C., the reaction mechanism changed. At this temperature the Ge dissolved with a very high kinetic rate coefficient in time period 60-240 min. The kinetic mechanism at this period was thought to be interfacial transfer and diffusion across the product layer. This means that increasing in temperature to 90° C. shifted the leaching mechanism from diffusion control to interfacial transfer and diffusion across the product layer. This could have occurred because the Ge and GeO oxidation were done faster at higher temperature.

TABLE 2
Kinetic mechanism, correlation coefficients and rate coefficients for different
parameters, at different time periods

| | | Time | | | |
|---|---|---|---|---|---|
| | | period | | Correlation | Rate |
| parameter | Value | (min) | Mechanism | coefficients | coefficients |
| Acid content | 2.5 | 5-60 | diffusion control | 0.92 | 6.61 × 10⁻⁵ |
| (M) | | | interfacial transfer and | | |
| | | 60-240 | diffusion across the product | 0.96 | 0.00042 |
| | | | layer | | |
| | | 240- | Equilibrium | — | — |
| | | 390 | | | |
| | | 5-60 | diffusion control | 0.86 | 6.94 × 10⁻⁵ |
| | | | interfacial transfer and | | |
| | 5 | 60-240 | diffusion across the | 0.97 | 0.00038 |
| | | | product layer | | |
| | | 240- | Equilibrium | — | — |
| | | 390 | | | |
| | | 5-60 | diffusion control | 0.90 | −6.89 × 10⁻⁵ |
| | | | interfacial transfer and | | |
| | 7.5 | 60-240 | diffusion across the | 0.99 | 0.00019 |
| | | | product layer | | |
| | | 240- | Equilibrium | — | — |
| | | 390 | | | |
| Agitation | 300 | 5-390 | diffusion control | 0.96 | −8.30 × 10⁻⁶ |
| rate (rpm) | 450 | 5-60 | diffusion control | 0.92 | 6.61 × 10⁻⁵ |
| | | | interfacial transfer and | | |
| | | 60-240 | diffusion across the product | 0.96 | 0.00042 |
| | | | layer | | |
| | | 240- | Equilibrium | — | — |
| | | 390 | | | |
| | | 5-60 | diffusion control | 0.93 | 3.61 × 10⁻⁵ |
| | 600 | 60-240 | diffusion control | 0.99 | 0.00036 |
| | | 240- | Equilibrium | — | — |
| | | 390 | | | |
| Temperature | 30 | 5-30 | diffusion control | 0.93 | 4.15 × 10⁻⁵ |
| (° C.) | | 30-390 | diffusion control | 0.93 | 5.06 × 10⁻⁶ |
| | | 5-240 | diffusion control | 0.92 | 1.32 × 10⁻⁵ |
| | 50 | 240- | diffusion control | 0.92 | 7.86 × 10⁻⁵ |
| | | 390 | | | |
| | | 5-120 | diffusion control | 0.91 | 6.33 × 10⁻⁵ |
| | 70 | 120- | diffusion control | 0.97 | 0.00015 |
| | | 390 | | | |
| | | 5-60 | diffusion control | 0.92 | 6.61 × 10⁻⁵ |
| | | | interfacial transfer and | | |
| | 90 | 60-240 | diffusion across the product | 0.96 | 0.00042 |
| | | | layer | | |
| | | 240- | Equilibrium | — | — |
| | | 390 | | | |

Validation of Kinetic Modeling

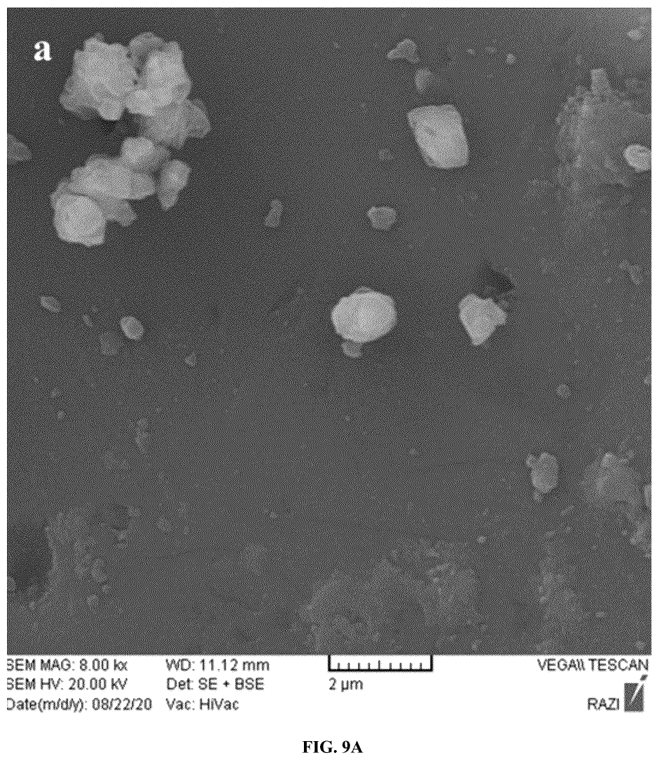

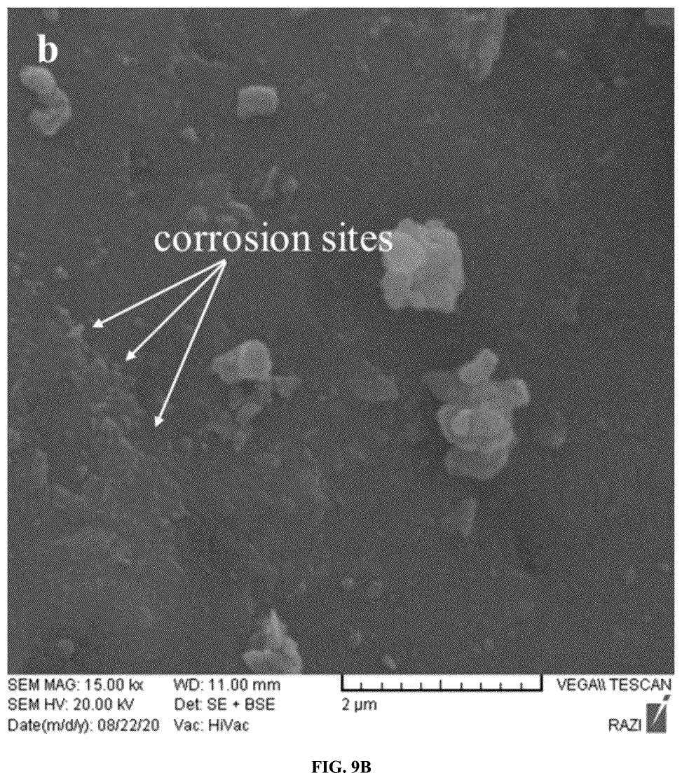

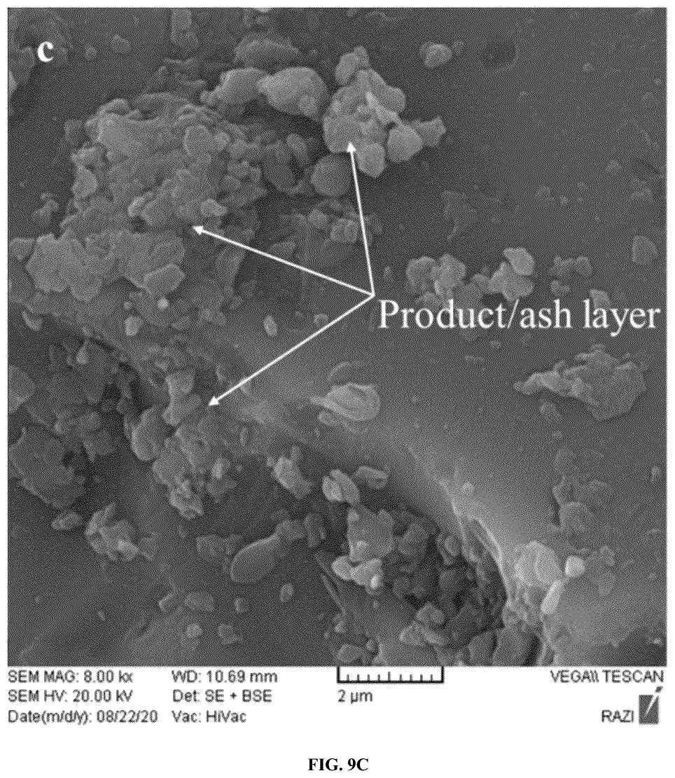

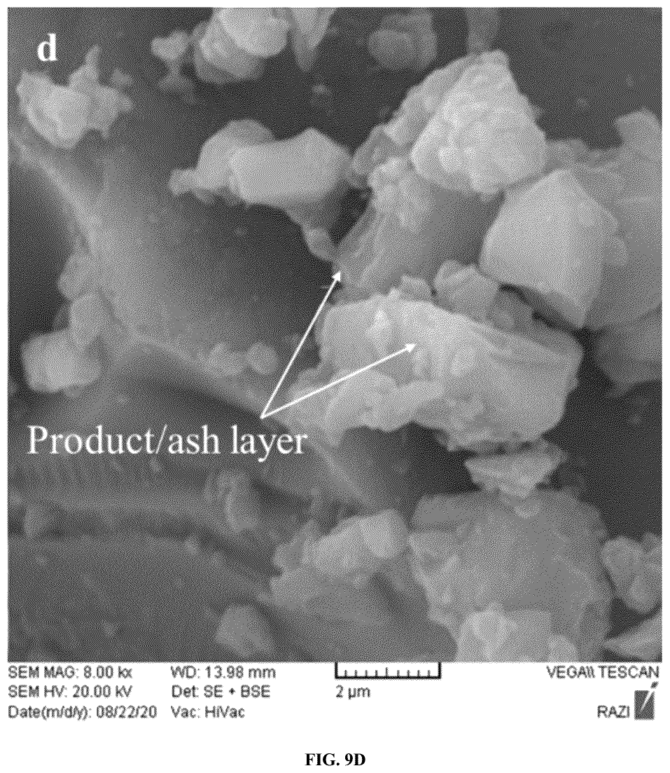

SEM and EDS analyses were employed to study the morphology and chemical shift during leaching, to validate the kinetic modeling. For this purpose, the leaching residuals after 5 min, 90 min, 200 min, and 360 min processing (for test with optimum conditions) were used for SEM-EDS analysis (FIGS. 9A-9D). As FIG. 9A shows, the particle surface was smooth after 5 min leaching. In the second leaching phase, the corrosion sites were formed in the particles surface (FIG. 9B). These sites were formed due to the reaction between leaching reagent and solid matrix. On the other hand, significant changes in surface morphology were detected in leaching residuals for phase 3 and phase 4 (FIGS. 9C and 9D) in comparison to phase 1 and 2. The product/ash layer (white particles) started to form in the particles surface for leaching residual (dark phase) at phase 3. The crystals with a size of 0.5 to 2 m were formed in the particles' surface in this stage. With the passage of time, the particles of product layer increased to around 2 to 5 m. In other words, the particles surface covered with larger particle by the passage of time which prevent the reagent diffusion to the surface and limit the leaching process. It should be noted that SEM images were taken in backscattering mode. The differences of color between dark and white particles showed that they had different compositions.

The kinetic modeling and SEM studies were in great agreement with each other. The results showed that during the first leaching phase the particle surface was smooth and without any effect of reaction. As kinetic modeling showed diffusion control is rate limiting step in third phase. As SEM image (FIGS. 9C and 9D) shows, the particles did not contain any porosity which means that reagent cannot diffuse to the particles' depth and reaction was just carried out at the particles' surface. Therefore, covering the surface of the particles with ash/product layer caused to stop the reaction. The EDS analysis showed that Si concentration in the particles surface increased from 22% to more than 26% by the passage of time. This suggests that formation of a high Si layer may prevent reagent diffusion to the surface.

To summarize, although the recycling of different metals from printed circuit board (PCBs) has been investigated widely, the recycling of Ge from this resource has been less studied. As widely used electronic parts, germanium diodes can be an important resource for Ge recycling from PCBs. Herein, extraction of germanium from diodes with acetic acid was investigated. The effect of acetic acid concentration, stirring speed, and temperature was examined on Ge leaching kinetic. The results showed that more than 70% of Ge was leached after 240 min processing, at 2.5 M of acetic acid 450 rpm of agitation rate and temperature of 90° C. The Ge dissolution from diodes followed three main phases. In the first phase, the germanium recovery reached ˜30% with a very fast kinetic rate, which was attributed to dissolution of GeO₂. The Ge leaching was stopped at the second phase. The diffusion control was thought to be the rate-limiting step in this phase. After passing around 60 min, the 3rd phase started and germanium was dissolved with high kinetic rate, and subsequently the reaction reached equilibrium. In the second phase Ge and GeO were oxidized to the GeO₂ which is soluble and leached in the third phase.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

### REFERENCES

A number of patents and publications were cited above in order to more fully describe and disclose the invention and the state of the art to which the invention pertains. Full citations for these references were provided below. Each of these references is incorporated herein by reference in its entirety into the present disclosure, to the same extent as if each individual reference was specifically and individually indicated to be incorporated by reference.
ADDIN Mendeley Bibliography CSL_BIBLIOGRAPHY Asadi, M., Mohammadi, M. R. T., Moosakazemi, F., Esmaeili, M. J., Zakeri, M., 2018. Development of an environmentally friendly flowsheet to produce acid grade fluorite concentrate. J. Clean. Prod. 186, 782-798. https://doi.org/10.1016/J.JCLEPRO.2018.03.118
Aydogan, S., Aras, A., Canbazoglu, M., 2005. Dissolution kinetics of sphalerite in acidic ferric chloride leaching. Chem. Eng. J. 114, 67-72. https://doi.org/10.1016/J.CEJ.2005.09.005
Behera, S. S., Parhi, P. K., 2016. Leaching kinetics study of neodymium from the scrap magnet using acetic acid. Sep. Purif. Technol. 160, 59-66. https://doi.org/https://doi.org/10.1016/j.seppur.2016.01.014
Chen, W. S., Chang, B. C., Chen, Y. J., 2018. Using Ion-Exchange to Recovery of Germanium from Waste Optical Fibers by Adding Citric Acid. IOP Conf. Ser. Earth Environ. Sci. 159. https://doi.org/10.1088/1755-1315/159/1/012008
Chen, W. S., Chang, B. C., Chiu, K. L., 2017. Recovery of germanium from waste Optical Fibers by hydrometallurgical method. J. Environ. Chem. Eng. 5, 5215-5221. https://doi.org/10.1016/j.jece.2017.09.048
Dhiman, S., Gupta, B., 2020. Recovery of pure germanium oxide from Zener diodes using a recyclable ionic liquid Cyphos IL 104. J. Environ. Manage. 276, 111218. https://doi.org/https://doi.org/10.1016/j.jenvman.2020.111218
Dickinson, C. F., Heal, G. R., 1999. Solid-liquid diffusion controlled rate equations. Thermochim. Acta 340-341, 89-103. https://doi.org/10.1016/S0040-6031(99)00256-7
Dreisinger, D., Abed, N., 2002. A fundamental study of the reductive leaching of chalcopyrite using metallic iron part I: kinetic analysis. Hydrometallurgy 66, 37-57. https://doi.org/10.1016/S0304-386X(02)00079-8
Drzazga, M., Chmielarz, A., Benke, G., Leszczynska-Sejda, K., Knapik, M., Kowalik, P., Ciszewski, M., 2019. Precipitation of germanium from sulphate solutions containing tin and indium using tannic acid. Appl. Sci. 9. https://doi.org/10.3390/app9050966
European Commission, 2017. Commission of European Communities. Communication on the 2017 list of Critical Raw Materials for the EU (COM no. 490). https://doi.org/10.1017/CB09781107415324.004
Gan, N., Ogawa, Y., Nagai, T., Masaoka, T., Wostyn, K., Sebaai, F., Holsteyns, F., Mertens, P. W., 2015. Dissolution of Germanium in Sulfuric Acid Based Solutions. ECS Trans. 69, 277-284. https://doi.org/10.1149/06908.0277ecst
Gao, G., Li, D., Zhou, Y., Sun, X., Sun, W., 2009. Kinetics of high-sulphur and high-arsenic refractory gold concentrate oxidation by dilute nitric acid under mild conditions. Miner. Eng. 22, 111-115. https://doi.org/10.1016/J.MINENG.2008.05.001
Ghassa, S., Noaparast, M., Shafaei, S. Z., Abdollahi, H., Gharabaghi, M., Boruomand, Z., 2017. A study on the zinc sulfide dissolution kinetics with biological and chemical ferric reagents. Hydrometallurgy 171, 362-373. https://doi.org/10.1016/J.HYDROMET.2017.06.012
Ghassa, S., Noaparast, M., Shafaei, S. Z., Abdollahi, H., Gharabaghi, M., Boruomand, Z., 2017. A study on the zinc sulfide dissolution kinetics with biological and chemical ferric reagents. Hydrometallurgy 171. https://doi.org/10.1016/j.hydromet.2017.06.012
Hashim, S., Al-Ahbabi, S., Bradley, D. A., Webb, M., Jeynes, C., Ramli, A. T., Wagiran, H., 2009. The thermoluminescence response of doped SiO2 optical fibres subjected to photon and electron irradiations. Appl. Radiat. Isot. 67, 423-427. https://doi.org/10.1016/j.apradiso.2008.06.030
Ikiz, D., Gülfen, M., Aydin, A. O., 2006. Dissolution kinetics of primary chalcopyrite ore in hypochlorite solution. Miner. Eng. 19, 972-974. https://doi.org/10.1016/J.MINENG.2005.09.047
Jing, C., Hou, J., Zhang, Y., 2008. Morphology controls of GeO2 particles precipitated by a facile acid-induced decomposition of germanate ions in aqueous medium. J. Cryst. Growth 310, 391-396. https://doi.org/https://doi.org/10.1016/j.jcrysgro.2007.10.021
Jorgenson, J. D., 2003. Mineral resource of the month: germanium. Geotimes 2003.
Kamran Haghighi, H., Irannajad, M., Fortuny, A., Sastre, A. M., 2019. Selective separation of Germanium(IV) from simulated industrial leachates containing heavy metals by non-dispersive ionic extraction. Miner. Eng. 137, 344-353. https://doi.org/10.1016/j.mineng.2019.04.021
Kuroiwa, K., Ohura, S., Morisada, S., Ohto, K., Kawakita, H., Matsuo, Y., Fukuda, D., 2014. Recovery of germanium from waste solar panels using ion-exchange membrane and solvent extraction. Miner. Eng. 55, 181-185. https://doi.org/https://doi.org/10.1016/j.mineng.2013.10.002
Lehmann, F., Daus, B., Reemtsma, T., 2019. Germanium speciation using liquid chromatography-inductively coupled plasma-triple quadrupole mass spectrometry: Germanium in biological and chemical leaching solutions of fine-grained residues from copper smelting. J. Chromatogr. A 1593, 47-53. https://doi.org/https://doi.org/10.1016/j.chroma.2019.01.061
Levenspiel, O., 1999. Chemical Reaction Engineering. Wiley, New York.
Liu, D., Liu, H., Jiang, C., Leng, J., Zhang, Y., Zhao, Z., Zhuang, K., Jiang, Y., Ji, Y., 2015. Temperature dependence of the infrared optical constants of germanium films, in: Thin Solid Films. Elsevier, pp. 292-295. https://doi.org/10.1016/j.tsf.2015.06.029
Mercer, C. N., 2015. Germanium—Giving Microelectronics an Efficiency Boost 2020, 1-2.
Moosakazemi, F., Ghassa, S., Mohammadi, M. R. T., 2019a. Environmentally friendly hydrometallurgical recovery of tin and lead from waste printed circuit boards: Thermodynamic and kinetics studies. J. Clean. Prod. https://doi.org/10.1016/J.JCLEPRO.2019.04.024
Moosakazemi, F., Ghassa, S., Soltani, F., Tavakoli Mohammadi, M. R., 2019b. Regeneration of Sn—Pb solder from waste printed circuit boards: A hydrometallurgical approach to treating waste with waste. J. Hazard. Mater. 121589. https://doi.org/10.1016/J.JHAZMAT.2019.121589
Moskalyk, R. R., 2004. Review of germanium processing worldwide. Miner. Eng. 17, 393-402. https://doi.org/10.1016/j.mineng.2003.11.014
Noor, N. M., Hussein, M., Bradley, D. A., Nisbet, A., 2011. Investigation of the use of Ge-doped optical fibre for in vitro IMRT prostate dosimetry. Nucl. Instruments Methods Phys. Res. Sect. A Accel. Spectrometers, Detect. Assoc. Equip. 652, 819-823. https://doi.org/10.1016/j.nima.2010.09.085
Noor, N. M., Hussein, M., Kadni, T., Bradley, D. A., Nisbet, A., 2014. Characterization of Ge-doped optical fibres for MV radiotherapy dosimetry. Radiat. Phys. Chem. 98, 33-41. https://doi.org/10.1016/j.radphyschem.2013.12.017
Padilla, R., Pavez, P., Ruiz, M. C., 2008. Kinetics of copper dissolution from sulfidized chalcopyrite at high pressures in H2SO4-O2. Hydrometallurgy 91, 113-120. https://doi.org/10.1016/J.HYDROMET.2007.12.003
Pokrovski, G. S. and Schott, J., 1998. Experimental study of the complexation of silicon and germanium with aqueous organic species: implications for germanium and silicon transport and Ge/Si ratio in natural waters. Geochim. Cosmochim. Acta 62, 3413-3428.
Rao, S., Wang, D., Liu, Z., Zhang, K., Cao, H., Tao, J., 2019. Selective extraction of zinc, gallium, and germanium from zinc refinery residue using two stage acid and alkaline leaching. Hydrometallurgy 183, 38-44. https://doi.org/10.1016/j.hydromet.2018.11.007
Schulz, K. J., DeYoung John H., J., Seal, R. R., Bradley, D. C. (Eds.), 2017. Critical mineral resources of the United States-Economic and environmental geology and prospects for future supply, Professional Paper. Reston, VA. https://doi.org/10.3133/pp1802
Sokid, M. D., Marković, B., Živković, D., 2009. Kinetics of chalcopyrite leaching by sodium nitrate in sulphuric acid. Hydrometallurgy 95, 273-279. https://doi.org/10.1016/J.HYDROMET.2008.06.012
Ting, Lu, R. K., 1991. Viscous Vortical Flows. Springer-Verlag, Berlin Heidelberg. https://doi.org/10.1007/3-540-53713-9
Wang, H. H., Li, G. Q., Zhao, D., Ma, J. H., Yang, J., 2017. Dephosphorization of high phosphorus oolitic hematite by acid leaching and the leaching kinetics. Hydrometallurgy 171, 61-68. https://doi.org/https://doi.org/10.1016/j.hydromet.2017.04.015
Wood, S. A., Samson, I. M., 2006. The aqueous geochemistry of gallium, germanium, indium and scandium. Ore Geol. Rev. 28, 57-102. https://doi.org/https://doi.org/10.1016/j.oregeorev.2003.06.002
Zhang, L., Guo, W., Peng, J., Li, J., Lin, G., Yu, X., 2016. Comparison of ultrasonic-assisted and regular leaching of germanium from by-product of zinc metallurgy. Ultrason. Sonochem. 31, 143-149. https://doi.org/10.1016/j.ultsonch.2015.12.006
Zhang, L., Xu, Z., 2016. An environmentally-friendly vacuum reduction metallurgical process to recover germanium from coal fly ash. J. Hazard. Mater. 312, 28-36. https://doi.org/10.1016/j.jhazmat.2016.03.025

We claim:

1. A method of extracting germanium from electronic waste, comprising:
a) grinding an electronic waste material comprising germanium to generate a mixture of particulate solids;
b) leaching the mixture of particulate solids with a leaching solution;
wherein the leaching solution comprises water and a lixiviant; and
wherein the lixiviant comprises at least an organic acid.

1. The method of claim 1, wherein the organic acid has a pKa in a range of from about 4 to about 5.

2. The method of claim 1, wherein the organic acid is miscible with water at 25° C.

3. The method of claim 1, wherein the lixiviant further comprises a mineral acid.

4. The method of claim 1, wherein the organic acid comprises at least one carboxylic acid group.

5. The method of claim 1, wherein the organic acid comprises acetic acid.

6. The method of claim 1, wherein said method further comprises, prior to step b), a step al) of subjecting the mixture of particulate solids to a magnetic force for removal of magnetic particles.

7. The method of claim 1, wherein the electronic waste material comprises any one of an optical fiber, a diode, light bulb filament, a smartphone, a liquid crystal display, an electronic semiconductor, a battery, a solar panel, a semiconductor, or a circuit board.

8. The method of claim 1, wherein the electronic waste material comprises an electronic component.

9. The method of claim 1, wherein the mixture of particulate solids comprises GeO and/or GeO₂.

10. The method of claim 1, wherein the germanium is present in the solid material in an amount up to about 10000 ppm.

11. The method of claim 1, wherein the organic acid is acetic acid and wherein the concentration of acetic acid in the leaching solution is in a range of from about 1 M to about 10 M.

12. The method of claim 1, wherein the leaching is performed for a duration of from about 5 minutes to about 360 minutes.

13. The method of claim 1, wherein the mixture of particulate solids has a d₈₀ particle size in a range of from about 10 micrometers to about 100 micrometers.

14. The method of claim 1, wherein the leaching solution and mixture of particulate solids have an initial volume/weight ratio in a range of from 10:1 to about 1000:1.

15. Recovered germanium, wherein said germanium is recovered using a method of claim 1.
